(19) United States
(12) Patent Application Publication
(10) Pub. No.: US 2025/0148285 A1
(43) Pub. Date: May 8, 2025

(54) FUNCTIONAL ACTIVATION-BASED ANALYSIS OF DEEP NEURAL NETWORKS

(71) Applicant: The Medical College of Wisconsin, Inc., Milwaukee, WI (US)

(72) Inventors: Andrew Scott Nencka, Franklin, WI (US); Lutfi Tugan Muftuler, Milwaukee, WI (US); Peter LaViolette, Milwaukee, WI (US); Kevin Matthew Koch, Milwaukee, WI (US)

(21) Appl. No.: 18/936,458

(22) Filed: Nov. 4, 2024

Related U.S. Application Data
(60) Provisional application No. 63/596,227, filed on Nov. 3, 2023.
(60) Provisional application No. 63/596,857, filed on Nov. 7, 2023.

(51) Int. Cl. G06N 3/082

(52) U.S. Cl. CPC G06N 3/082

(57) ABSTRACT

Functional activation-based analysis of deep neural networks uses a structured set of inputs (e.g., input datasets corresponding to different knowledge or datatype domains) are sequentially provided to a pretrained neural network (e.g., according to a block-sequence). The output values for each node in the neural network are recorded and stored as a time-series of layer output values. A statistical analysis of the time-series of layer output values may be fit as a function of the structured set of inputs to generate neural network analysis data that indicate activations of layers within the neural network based on the inputs.

### CROSS-REFERENCE TO RELATED APPLICATIONS

This application claims the benefit of U.S. Provisional Patent Application Ser. No. 63/596,227, filed on Nov. 3, 2023, and entitled “FUNCTIONAL ACTIVATION-BASED ANALYSIS OF DEEP NEURAL NETWORKS,” and claims the benefit of U.S. Provisional Patent Application Ser. No. 63/596,857, filed on Nov. 7, 2023, and entitled “FUNCTIONAL ACTIVATION-BASED ANALYSIS OF DEEP NEURAL NETWORKS,” both of which are herein incorporated by reference in their entirety.

### BACKGROUND

Deep neural networks are powerful computational tools for modeling, prediction, and content generation. However, the inner workings of these models have generally been opaque. Recent work has shown that the performance of some models are modulated by overlapping functional networks of connections within the models.

In one example, prior techniques for explainable artificial intelligence (AI) used a localization process, in which the precise position (e.g., a single neuron, an attention head, an activation subspace, a computational graph) within a neural network that defines a specific behavior is located. These techniques have the drawback that focusing on particular components within a neural network may result in overfitting, reducing overall model performance, and/or reducing overall model generalizability. Additionally, these techniques suffer from scalability issues. Localization techniques become increasingly difficult to scale as the neural network to be analyzed grows in size and complexity.

In another example, prior techniques for explainable AI used a sparse autoencoder approach, in which a set of meaningful features that exist in a sparse, high-dimensional space are extracted. These features can be linearly combined to produce activation vectors of the model. These techniques have the drawback that the extracted features do not always align with a human understanding of a topic-of-interest relevant to the neural network model. Additionally, these techniques also suffer from scalability issued. The size of the autoencoder needs to increase with the neural network size and the feature space being abstracted. There is no standard way to estimate the maximum size needed to capture the complete set of features.

### SUMMARY OF THE DISCLOSURE

It is an aspect of the present disclosure to provide a method for analyzing an artificial neural network. The method includes accessing input data with a computer system, where the input data may include a first input dataset and a second input dataset; accessing a pretrained neural network with the computer system, the pretrained neural network may include a plurality of layers; forming a block-sequence of the input data that defines an order to apply the first input data set and the second input dataset to the pretrained neural network; generating a time-series of layer output values by: applying the input data to the pretrained neural network according to the block-sequence; storing an output of each of the plurality of layers generated when applying the input data to the pretrained neural network according to the block-sequence; where the output of each of the plurality of layers are ordered based on the block-sequence and define the time-series of layer output values. The method also includes generating neural network activation data by processing the time-series of layer output values with the computer system, where the neural network activation data indicate a degree of activation of each of the plurality of layers of the pretrained neural network in response to at least one of the first input dataset or the second input dataset. Other embodiments of this aspect include corresponding systems (e.g., computer systems), programs, algorithms, and/or modules, each configured to perform the steps of the methods.

It is another aspect of the present disclosure to provide a method for analyzing an artificial neural network. The method includes accessing input data with a computer system, where the input data may include a structured set of inputs; accessing a pretrained neural network with the computer system, the pretrained neural network may include a plurality of layers; sequentially applying the structured set of inputs of the input data to the pretrained neural network, generating a time-series of layer output values; generating neural network activation data by fitting the time-series of layer output values to a statistical model. Other embodiments of this aspect include corresponding systems (e.g., computer systems), programs, algorithms, and/or modules, each configured to perform the steps of the methods.

### BRIEF DESCRIPTION OF THE DRAWINGS

FIG. 1 is a flowchart of an example method for generating neural network activation data based on the application of different input datasets to the neural network according to a temporally ordered block-sequence of the input data.

FIG. 2 is a flowchart of an example method for generating neural network activation data based on the application of a structured set of inputs to the neural network in a sequential, or otherwise time-ordered, manner.

FIG. 3 shows an example time-series of layer output values (blue) for an element that was identified to be active and the fit activation time series profile (red).

FIG. 4 shows Venn diagrams showing the overlap of network activations across tasks for an example experimental run.

FIG. 5 shows Venn diagrams illustrating the overlap of activations across runs for matched tasks.

FIG. 6 shows the percentage of functional network active for each held out experiment and each functional network. The high values on the diagonal indicate that this metric successfully identifies task based upon measured activations.

FIG. 7 is a block diagram of an example neural network analysis system that can implement the methods described in the present disclosure.

FIG. 8 is a block diagram of example components that can implement the system of FIG. 7.

### DETAILED DESCRIPTION

Described here are systems and methods for functional activation-based analysis of deep neural networks. The disclosed systems and methods provide an explainable artificial intelligence (XAI) framework that enables an understanding of the inner workings of a deep neural network. In general, a structured set of inputs are sequentially provided to the model, and the output values for each node in the model's neural network are recorded. Following the techniques of functional neuroimaging, a statistical analysis of the generated series of node outputs (i.e., a time-series of layer output values) is fit as a function of the structured set of inputs (i.e. a “task” in the vernacular of functional neuroimaging).

An example embodiment with a large language model (LLM) is described in more detail below. In this case series of prompts related to different semantic tasks were provided as input to a LLM in an off/on/off block design. Different, partially overlapping functional sub-networks of the model were identified which were preferentially active for each task.

The disclosed systems and methods advantageously provide insight into the opaque box of machine learning algorithms. By identifying functional networks in a large model, one can have the opportunity predict model inputs/outputs (applications possible in model alignment), observe aberrant model behavior (applications possible in model alignment and focused model fine tuning), and proactively identify model performance divergence (applications possible in model alignment).

Regarding model alignment, a great deal of resources are employed with deep neural networks, specifically large language models, to ensure that unfavorable or divergent outputs are repressed by the model. By understanding the activations within the network, one can identify functional networks that are associated with aligned versus unaligned performance, and censor or modify outputs when unaligned performance networks are activated. This offers an opportunity to align the model without resorting to re-training or fine tuning-both of which take significant resources and can result in degraded model performance.

Regarding model fine tuning, identifying networks within the model associated with a task can allow fine tuning to specifically target those networks. This can be achieved by “unfreezing” those nodes for the fine tuning. This is a more targeted approach to fine tuning compared to the traditional techniques of unfreezing full layers of the network or adding new intermediate layers for tuning.

With a more interpretable understanding of the underlying mechanisms of a neural network, numerous advantages can be realized. For example, with the functions of different sub-networks within a neural network identified, the neural network may be steered from undesirable behaviors towards more desirable outcomes. As another advantage, the performance of the neural network may be assessed based on the activation of a set of sub-networks prior to the completion of an inference task, thereby offering a mechanism to modulate neural network output.

Advantageously, the systems and methods described in the present disclosure can be used in a variety of applications and downstream tasks. For instance, generating neural network activation data that indicate how different components of a pretrained neural network are activated by different inputs can assist with model distillation, developer debugging, and model comparison and/or validation tasks.

Additionally or alternatively, the disclosed systems and methods can be used by model developers to determine and implement behavioral changes in a pretrained neural network. In these instances, the neural network activation data can be used to identify specific subnetworks that are activated in the pretrained neural network. Model weights can then be modulated to affect the behavior of these subnetworks and thus the overall pretrained neural network.

As another example, the disclosed systems and methods can be used by governments, regulatory agencies, audit services, or the like, the perform white-box auditing and guardrail setting of a pretrained neural network. In these instances, model weights and concepts can be passed to the pretrained neural network and the resulting neural network activation data can be used to identify connections or otherwise visualize the outputs of the pretrained neural network. This feature explorer can enable more robust auditing of a pretrained neural network.

In still another example, the disclosed systems and methods can be used by product developers or AI governance entities to set guardrails on a pretrained neural network. In these instances, critical concepts and/or topics can be identified and used to generate neural network activation data. The weights identified in the critical network activation can then be modulated (e.g., down-regulated) to implement guardrails on the pretrained neural network.

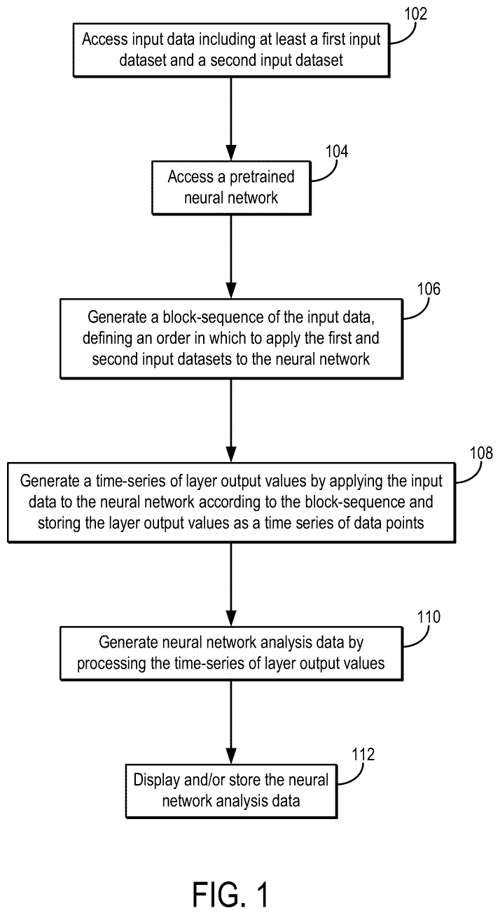

Referring now to FIG. 1, a flowchart is illustrated as setting forth the steps of an example method for generating neural network activation data by applying different inputs or datasets to a pretrained neural network according to a temporally ordered block-sequence to evaluate how each layer in the pretrained neural network is preferentially activated by the different inputs and/or datasets.

The method includes accessing or otherwise receiving input data with a computer system, as indicated at step 102. Accessing the input data may include retrieving such data from a memory or other suitable data storage device or medium. Additionally or alternatively, accessing the input data may include acquiring such data and transferring or otherwise communicating the data to the computer system.

The input data can include a first input dataset and a second input dataset. In general, the first input dataset is associated with a first domain and the second input dataset is associated with a second domain. As one example, the first domain and the second domain may be different knowledge domains. More generally, the input data may include a plurality of input datasets corresponding to a plurality of different domains (e.g., different knowledge domains). Additionally or alternatively, the plurality of input datasets may correspond to different data types within the same knowledge domain. In these contexts, the first domain may correspond to a first datatype domain and the second domain may correspond to a second datatype domain. As a non-limiting example, a first datatype domain may include medical images and a second datatype domain may include radiology notes associated with the medical images, or other patient health data.

In general, a knowledge domain corresponds to a specific area or field of knowledge or expertise in which information, concepts, and principles are organized and categorized. Data associated with a knowledge domain may include textual information, experimental data, biological data, medical data, audio data, visual data, sensor data, financial data, economic data, social media data, marketing data, other types of structured datasets or unstructured datasets, and so on. Textual information may include written documents, messages, or other text information that convey information about the related knowledge domain. Experimental data may include data collected from experiments, observations, and/or measurements associated with the related knowledge domain. For instance, experimental data may include numerical measurements. Biological data may include genomic data or other omics data. Medical data may include patient health data or other related clinical data. In some instances, medical data may include medical images, clinical laboratory test values, and so on. Audio and visual data may include content such as recordings, images, videos, and the like. Sensor data may include data acquired from sensors in various applications, such as physiological sensors, environmental sensors, internet-of-things (IoT) sensors, and the like. Financial and economic data may include data related to financial markets, economic indicators, various financial instruments, and the like. Social media data may include data collected from, or related to, social media platforms. Marketing data may include data related to or associated with marketing strategy, advertising, content creation (e.g., white papers, brochures), market research, sales, product information, customer preferences, and the like.

Knowledge domains can be broad, or may be more specialized subdomains. For example, a medical knowledge domain may encompass various subdomains (e.g., radiology, pathology, neurology, etc.). The first and second domains may, therefore, correspond to different broad knowledge domains, a broad knowledge domain and a subdomain of that broad knowledge domain, different subdomains of a common broad knowledge domain, different subdomains of different broad knowledge domains, and so on.

Without loss of generality, examples of knowledge domains may include medical, biological, financial, economic, social, marketing, scientific, and so on. Medical knowledge domains may include subdomains such as radiology, pathology, oncology, neurology, and the like. Biological knowledge domains may include genetics, microbiology, molecular biology, pharmacology, immunology, botany, bioinformatics, and the like. Social knowledge domains may include subdomains such as sociology, psychology, anthropology, political science, demography, and the like. Marketing knowledge domains may include subdomains such as market research, advertising, brand management, sales and promotions, product knowledge, costumer relationship management, analytics, and the like. Scientific knowledge domains may include subdomains such as physics, chemistry, biology, geology, paleontology, meteorology, material science, engineering, and the like.

A pretrained neural network, or other suitable machine learning model, is then accessed with the computer system, as indicated at step 104. The pretrained neural network may be any suitable neural network or neural network-based machine learning model, such as feed forward neural networks, convolutional neural networks, recurrent neural networks, long short-term memory (LSTM) networks, gated recurrent units, generative adversarial networks (GANs), autoencoders, transformers, graph neural networks (GNNs), and so on. As one non-limiting example, the pretrained neural network may be a implemented as part of a large language model (LLM), such as those using a generative pretrained transformer (GPT) model, a bidirectional encoder representations from transformers (BERT) model, or the like. As another non-limiting example, the pretrained neural network may be implemented as part of a vision transformer.

Accessing the pretrained neural network may include accessing network parameters (e.g., weights, biases, or both) that have been optimized or otherwise estimated by training the neural network on training data. In some instances, retrieving the neural network can also include retrieving, constructing, or otherwise accessing the particular neural network architecture to be implemented. For instance, data pertaining to the layers in the neural network architecture (e.g., number of layers, type of layers, ordering of layers, connections between layers, hyperparameters for layers) may be retrieved, selected, constructed, or otherwise accessed.

In general, the pretrained neural network will include a plurality of layers. For instance, an artificial neural network generally includes an input layer, one or more hidden layers (or nodes), and an output layer. Typically, the input layer includes as many nodes as inputs provided to the artificial neural network. The number (and the type) of inputs provided to the artificial neural network may vary based on the particular task for the artificial neural network.

The input layer connects to one or more hidden layers. The number of hidden layers varies and may depend on the particular task for the artificial neural network. Additionally, each hidden layer may have a different number of nodes and may be connected to the next layer differently. For example, each node of the input layer may be connected to each node of the first hidden layer. The connection between each node of the input layer and each node of the first hidden layer may be assigned a weight parameter. Additionally, each node of the neural network may also be assigned a bias value. In some configurations, each node of the first hidden layer may not be connected to each node of the second hidden layer. That is, there may be some nodes of the first hidden layer that are not connected to all of the nodes of the second hidden layer. The connections between the nodes of the first hidden layers and the second hidden layers are each assigned different weight parameters. Each node of the hidden layer is generally associated with an activation function. The activation function defines how the hidden layer is to process the input received from the input layer or from a previous input or hidden layer. These activation functions may vary and be based on the type of task associated with the artificial neural network and also on the specific type of hidden layer implemented.

Each hidden layer may perform a different function. For example, some hidden layers can be convolutional hidden layers which can, in some instances, reduce the dimensionality of the inputs. Other hidden layers can perform statistical functions such as max pooling, which may reduce a group of inputs to the maximum value; an averaging layer; batch normalization; and other such functions. In some of the hidden layers each node is connected to each node of the next hidden layer, which may be referred to then as dense layers. Some neural networks including more than, for example, three hidden layers may be considered deep neural networks.

The last hidden layer in the artificial neural network is connected to the output layer. Similar to the input layer, the output layer typically has the same number of nodes as the possible outputs.

Each layer of the neural network generates one or more outputs that are passed as inputs to the next layer until the output layer, where the output(s) are stored as the overall output of the neural networks. As described below, the output values of each layer can be stored as a time point in a time-series of layer output values. Each time point in the time-series of layer output values may include a single data point (e.g., a single output value), a vector of data points, or a matrix of data points, depending on the number of nodes outputting data from the layer.

A block-sequence of the input data is then formed or otherwise generated, as indicated at step 106. The block-sequence defines an order to apply the first input data set and the second input dataset to the pretrained neural network. In general, the block-sequence includes a series of temporally ordered blocks, where each block corresponds to applying a particular input dataset to the neural network. As an example, the first input dataset can be associated with a first block type and the second input dataset can be associated with a second block type. Without loss of generality, the first block type may be an “OFF” state and the second block type may be an “ON” state. By way of example, for input data that include textual information, a block-sequence can be created as on/off blocks with sentences in stimulus areas and/or other areas.

The block types are then ordered in the block-sequence, such as by interleaving the first and second block types. As a non-limiting example, the block-sequence may include m first block types interleaved with n second block types. In some instances, n=m−1. For example, a block-sequence may include 11 blocks with 6 first block types and 5 second block types. In this example, the first block types may be interleaved with the second block types such that the block sequence begins and ends with a block of the first block type. Other block-sequence designs may also be used.

Additionally or alternatively, the input data can be arranged, assembled, or otherwise formed into a time-series of inputs. In some examples, the time-series can be created by token aggregation of the input data.

When constructing the block-sequence of input data, or the time-series of input data, a functional task for analyzing the pretrained neural network can be considered. For example, as in fMRI task design, the design of the “experimental” and “control” blocks can preferentially be constructed to include one change of interest, and to ensure that different runs are sufficiently independent. While other methods use optimization games and semi-supervised selection processes driven by loss criteria, it is an advantage of the disclosed systems and methods that a clear auxiliary supervised task can instead be formulated. This approach avoids the problem of mapping learned features to interpretable concepts (e.g., as in sparse autoencoders) and scales down the feature space to what is relevant in context. This latter advantage can reduce the computational complexity and resources needed for analyzing the pretrained neural network.

In the preceding example, the input data are ordered according to a block-sequence design before being applied to the pretrained neural network. More generally, the input data may be arranged as a structured set of inputs of the input data. As described above, in some examples, the structured set of inputs may form a block design, such as an off-on-off block sequence, or other suitable block sequence design.

Alternatively, the structured set of inputs may be arranged to form an event-related design. In an event-related design, the structured set of inputs may be arranged without a set sequence. For example, the arrangement of the inputs may be randomized, pseudorandomized, or may otherwise be arranged according to a particular process (or event) whose activation of the neural network is to be analyzed. Additionally or alternatively, the time between inputs can be varied by an inter-stimulus interval (ISI). Within the context of the systems and methods described in the present disclosure, varying the ISI may include applying random, or otherwise noisy, input data as a separate condition to approximate an ISI between inputs to the neural network. As another example, varying the ISI may include applying a zero-filled dataset to the neural network to approximate an ISI between inputs to the neural network. In any instances, the duration of the ISI can be varied according to a set sequence, or may be randomly varied. In other instances, the ISI may be fixed throughout the event sequence.

As a non-limiting example, an event may include applying an input dataset corresponding to a particular domain, datatype, or the like. For instance, the input data may include a plurality of input datasets containing visual data (e.g., images, such as medical images or the like), with different input datasets containing different types of images (e.g., images depicting different anatomical regions). The event may be selected as when a particular type of image (e.g., images generally depicting brains, images that are Tl-weighted images of the brain, images that are CT images of the brain, etc.) is presented to the neural network. Other analogous event-related designs may be adapted for use with the systems and methods described in the present disclosure.

In some embodiments, implementing an event-related design may include analyzing the time-series of layer output values based on the order in which the input datasets were applied to the neural network (e.g., the event sequence). By identifying the activations in each output layer responsive to different events, the neural network activation data can be generated. Statistical or other analytical methods for analyzing the time-series of layer output values according to an event-related design can be implemented.

The input data are then input to the pretrained neural network according to the block-sequence, as indicated at step 108. In doing so, a time-series of layer output values is generated by storing the output of each of the plurality of layers in the pretrained neural network according to the block-sequence. That is, as described above, the output values of each layer may be stored as a time point (e.g., a single output value, a vector of output values, a matrix of output values) in the time-series of layer output values. Each time point then corresponds to the output of a layer in the pretrained neural network, and these outputs are ordered according to the block-sequence. As a non-limiting example, for a neural network with five hidden layers and a block-sequence having a first block of a first block type and a second block of a second block type, the first five time points in the time-series of layer output values will correspond to the output values of the five hidden layers when applying the first input dataset to the neural network and the next five time points in the time-series of layer output values will correspond to the output values of the five hidden layers when applying the second input dataset to the neural network.

By way of example, for each target component of a pretrained LLM, the set of activations across all tokens in the time-series, or block-sequence, of input data are recorded as layer output values. In this way the hidden layer activations for the set of LLM outputs are recorded.

Neural network activation data are then generated by processing the time-series of layer output values with the computer system, as indicated at step 110. In general, the neural network activation data indicate a degree of activation of each of the plurality of layers of the pretrained neural network in response to the first input dataset and/or the second input dataset. As a non-limiting example, one or more functions can be fit to the time-series of layer output values to identify layer output values that were active with the tasks (i.e., active at certain layers based on the input dataset applied to the neural network for the different time points). The function(s) may include linear functions, nonlinear functions, or combinations thereof. As one example, the function may be a general linear models (GLM).

As another non-limiting example, the neural network activation data may include a heat map that depicts which neurons in the neural network are activated by the various inputs. Using such a heat map of exact neurons and labeling the heat map can provide improved visualization of the neural network activation data.

In some instances, temporal autocorrelations (or other response patterns, features, or functions) across the time-series of layer output values may be modeled in the statistical analysis used when generating the neural network activation data, similar to how a hemodynamic response function is modeled in fMRI analysis techniques. A response function that approximates the response pattern or features may be used in the analysis of the time-series of layer output values. As a non-limiting example, a design matrix used in a GLM-based analysis may be generated and used when analyzing the time-series of layer output values. For instance, the design matrix may be generated by convolving the response function with the block sequence.

By way of example, for n time series with binary labels for ON/OFF stimuli, n independent functions (e.g., GLMs, other linear functions, nonlinear functions) can be trained. In some instances, each neuron of the neural network is treated independently, such that its output values are fit to a function.

Additionally or alternatively, the neural network activation data may include neural network connectivity data. In these instances, the connections between layers may be analyzed based on temporal correlations and/or coherence between measured layer output values, similar to functional connectivity analyses performed in fMRI techniques. In this way, the neural network activation data may indicate how particular relevant features are connected within the neural network. This analysis can provide insights into which features impact the layer outputs across layers in the neural network, which can help identify subnetworks within the neural network, or the like. These types of neural network activation data may be generated based on an analysis of the time-series of layer output values according to so-called “task-free” or “resting-state” analysis techniques. As a non-limiting example, an active layer output, or a set of layer outputs, may be used as regressors in a task-free method. In some implementations, input datasets may be randomly or pseudorandomly applied to the neural network to approximate a “resting” state of the network. In these instances, the time-series of layer output values may be analyzed to identify spontaneous fluctuations, similar to resting-state fMRI techniques. Additional or alternative resting-state fMRI analysis techniques may be similarly adapted for analyzing the neural network.

In still other examples, analogs of psycho-physiological interactions (PPIs) may be analyzed in the time-series of layer output values. In these instances, neural network interactions are analyzed after regressing out any task effects from the time-series of layer output values.

In some implementations, the interpretable features of the neural network activation data can be further enhanced by considering correlations between neurons during activation. In these instances, it may be preferable to use a nonlinear function fitting for the layer output values.

The neural network activation data can then be displayed to a user, stored for later use or further processing, or both, as indicated at step 112.

As one example, the neural network activation data may indicate a subset of neural network components (e.g., a subset of LLM components) that are associated with a specific stimulus based on the predictive capacity of the model (e.g., based on ad hoc p-value thresholds). In this way, sets of neurons that can be associated with different types of stimuli are identified or otherwise depicted in the neural network activation data. This grouping of neurons can be used in many different downstream processing and analysis tasks. In some implementations, this process can be automated by using a metric that looks at neuron overlap with different groups and sparsity.

As another non-limiting example, the neural network activation data can be used in a model behavior regularization task. In these instances, groups of neural network activations can be segregated into groups based on the neural network activation data. Associated weights different stimuli can then be identified. For example, model weights that directly affect output activations can be identified. These model weights can then be upregulated and/or downregulated to weight the activations in the pretrained neural network. As one example, tensor values can be modified by one or more scalar values to regulate the behavior of the pretrained neural network. Advantageously, this model behavior regularization can be used to eliminate, or otherwise reduce, behavior modeled in a target stimulus group. In this way, constructing stimuli (e.g., block-sequences, event-related sequences, functional tasks) to analyze the effects of specific inputs on model behavior can be used to determine how to regulate those behaviors of the pretrained neural network. This approach can be used to identify and reduce model biases, among other behaviors.

In the methods described above, the input data are used as the regressor for the neural network analysis. In alternative embodiments, the output of the neural network may be used as the regressor for the neural network in a retrospective analysis. As one non-limiting example, an active layer output, or a set of layer outputs, may be used as regressors in a task-free method. Advantageously, the disclosed systems and methods can also be utilized to probe or otherwise analyze one or more domains based on model performance. For example, model performance can be analyzed for knowledge domain where the pretrained neural network is known to perform well. Additionally or alternatively, model performance can be analyzed from a knowledge domain where the pretrained neural network is known to perform poorly.

In addition to analyzing a neural network as described above, other neural network parameters or characteristics of the neural network may be varied, modulated, or otherwise used when generating the time-series of layer output values and/or neural network activation data. Without loss of generality, hyperparameters, learning parameters, or other neural network parameters, features, or characteristics may be modified or used when generating the time-series of layer output values and/or neural network activation data. For instance, some neural networks continue to learn as they are implemented. In these instances, the learning rates used by the neural network may be used as an additional or alternative parameter for analyzing the time-series of layer output values and/or generating the neural network activation data.

As noted above, the neural network activation data may be stored for later use or processing. In some examples, the neural network activation data may be used to guide model alignment, model improvement, and/or model compression.

For model alignment, the neural network activation data can be processed to monitor activations and identify if the output of the neural network model aligns with the objectives for which the model was designing and/or trained. When the activations of the neural network indicated that the model is becoming out of alignment with these objectives, then the neural network model can be adapted or updated based on the information contained in the neural network activation data. As one example, the output of a layer, node, or subgroup of nodes in a layer may be blocked to realign the model to its objectives. Additionally or alternatively, the input and/or weights of the neural network model may be modified to redirect the model to its objectives.

For model improvement, functional assessments of a neural network model can be performed using “tasks” of cases where the model performs sub-optimally. The identified activations of the model in the neural network activation data can then indicate which nodes in the neural network need to be retrained to improve its performance. This process can allow for specific model nodes to be identified and targeted for retraining and/or fine tuning instead of retraining and/or fine tuning the whole network, an additional network, or an arbitrary portion of the network. This can save large amounts of training time and costs.

For model compression, with active subnetworks identified for a given task, inactive nodes can be pruned if the neural network model is being optimized for a given task. For instance, the neural network activation data can be analyzed to identify subnetworks and/or nodes that are inactive. These identified subnetworks and/or nodes can then be pruned, trimmed, or otherwise suppressed in the neural network model to provide compression of the neural network model. This process reduces model size, thereby reducing the hardware requirements (i.e., by enabling the use of models embedded on site in industrial hardware and used in real-time) and computational expense.

In some additional examples, the neural network activation data may be analyzed or otherwise processed to monitor network activation patterns that can protect against jail breaking of the neural network and/or prompt safety features.

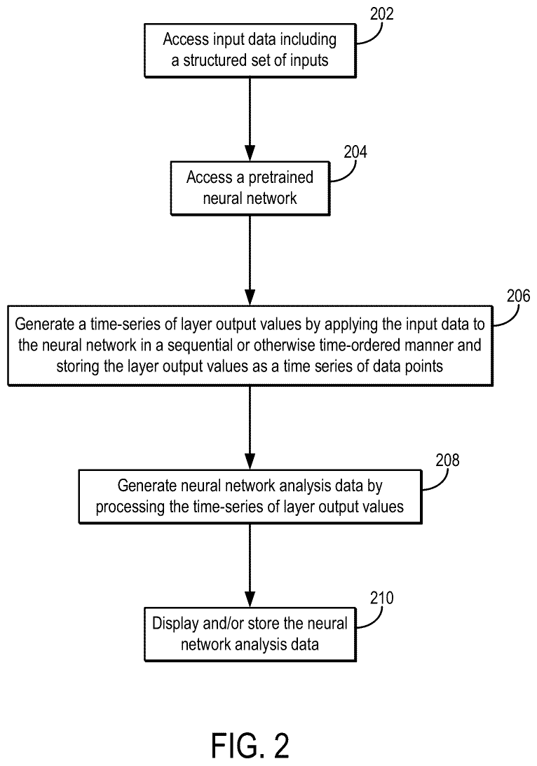

Referring now to FIG. 2, a flowchart is illustrated as setting forth the steps of another example method for generating neural network activation data by applying different inputs or datasets to a pretrained neural network according to a temporally ordered block-sequence to evaluate how each layer in the pretrained neural network is preferentially activated by the different inputs and/or datasets.

The method includes accessing or otherwise receiving input data with a computer system, as indicated at step 202. Accessing the input data may include retrieving such data from a memory or other suitable data storage device or medium. Additionally or alternatively, accessing the input data may include acquiring such data and transferring or otherwise communicating the data to the computer system.

The input data can include a structured set of inputs. As described above, the structured set of inputs may be arranged according to a block-sequence design and/or an event-related design. In still other examples, the structured sets of inputs may be arranged according to other designs, criteria, or conditions. The structured set of inputs may include data associated with one or more domains. For instance, the structured set of inputs may include data associated with one or more knowledge domains.

A pretrained neural network is then accessed with the computer system, as indicated at step 204. The pretrained neural network may be any suitable neural network or neural network-based machine learning model, such as feed forward neural networks, CNNs, recurrent neural networks, LSTM networks, gated recurrent units, GANs, autoencoders, transformers, GNNs, and so on. As described above, the pretrained neural network may be a implemented as part of an LLM, a vision transformer model, or the like.

Accessing the pretrained neural network may include accessing network parameters (e.g., weights, biases, or both) that have been optimized or otherwise estimated by training the neural network on training data. In some instances, retrieving the neural network can also include retrieving, constructing, or otherwise accessing the particular neural network architecture to be implemented. For instance, data pertaining to the layers in the neural network architecture (e.g., number of layers, type of layers, ordering of layers, connections between layers, hyperparameters for layers) may be retrieved, selected, constructed, or otherwise accessed.

A time-series of layer output values is then generated by inputting or otherwise applying the input data to the pretrained neural network, as indicated at step 206. For example, the time-series of layer output values can be generated by storing the output of each of the plurality of layers in the pretrained neural network as the input data are applied (e.g., sequentially applied, applied according to a block-sequence design, applied according to an event-related design, etc.). That is, as described above, the output values of each layer may be stored as a time point (e.g., a single output value, a vector of output values, a matrix of output values) in the time-series of layer output values. Each time point then corresponds to the output of a layer in the pretrained neural network, and these outputs are ordered according to how the input data were applied to the pretrained neural network.

Neural network activation data are then generated by processing the time-series of layer output values with the computer system, as indicated at step 208. In general, the neural network activation data indicate a degree of activation of each of the plurality of layers of the pretrained neural network in response to the first input dataset and/or the second input dataset. As described above, one or more functions can be fit to the time-series of layer output values to identify layer output values that were active with the tasks (i.e., active at certain layers based on the input dataset applied to the neural network for the different time points). Alternatively, the time-series of layer output values can be fit to the function(s). The function(s) may include linear functions, nonlinear functions, or combinations thereof. The function may be, for example, a statistical model. As one example, the function may be a GLM. As another non-limiting example, the neural network activation data may include a heat map (e.g., an activation heat map) that depicts which neurons in the neural network are activated by the various inputs. Additionally or alternatively, the neural network activation data can take other forms, such as those described above.

The neural network activation data can then be displayed to a user, stored for later use or further processing, or both, as indicated at step 210.

In an example study, the techniques of functional neuroimaging described above were applied to a large language model (LLM) to probe its functional structure. For instance, a series of block-designed task-based prompt sequences (e.g., a block-sequence of input data) were generated to probe the Facebook Galactica-125M model. The input data included various input datasets corresponding to different knowledge domains. Tasks included prompts relating to political science, medical imaging, paleontology, archeology, pathology, and random strings presented in an off/on/off pattern with prompts about other random topics. For the generation of each output token, all layer output values were saved to create an effective time series. General linear models were fit to the data to identify layer output values which were active with the tasks.

In this example, task-based functional mapping of the elements embedded in a deep neural network was performed. A brief description of how a functional neuroimaging experiment is performed is provided below, followed by a description of how the functional neuroimaging experiment paradigm can be adapted to the assessment of computed layer outputs throughout a deep neural network. This paradigm was then applied to an application of assessing subnetwork activation in the Facebook Galactica-125M model across a set of tasks spanning multiple knowledge domains.

Task-based functional MRI (fMRI) experiments include presenting a research participant with a known stimulus which is often organized into a series of “on” and “off” blocks, where the stimulus of interest is present (ON) or is not present (OFF). A time series of volumetric images of the brain are acquired while the task is presented, and each volume pixel (or voxel) of the brain is considered as a unique time series. A statistical model is fit to each imaged voxel time series to identify if the voxel's blood-oxygen-level-dependent (BOLD) contrast changes are related to the presented task. If they are found to correlate with the task, the voxel is identified to be “active,” and maps of active voxels across the brain are generated to identify the cortical network or networks associated with the presented task.

As described above, a deep neural network can be considered in a similar way to the brain in an fMRI experiment. As input data pass through the connections of a deep neural network, the values output from each node are input into following nodes as a product of the output value and the weight of the connection which is defined in training. Each of these connections can be considered to be analogous to a voxel in an fMRI experiment.

As with a task-based fMRI experiment, the neural network can be probed with a series of inputs related to, or not related to, a specific task in an a priori known pattern. The values passed through the neural network connections can be saved for each input, and a time series of layer outputs can be generated for each inference step of the model. In the case of a transformer used for a LLM, each time point in the generated series can correspond to an output token. With the time series of layer outputs retained, the statistical modeling developed in fMRI can be applied to the layer output value time series to determine which layer output connections are preferentially activated with the presented task.

With each layer output value considered individually, this technique is not compromised by the spatial averaging present in brain imaging. Additionally, with the task input explicitly interacting with the observed layer outputs, observed waveforms are not impacted by a physiologic response function, though attention mechanisms in a transformer may introduce a temporal autocorrelation. In these latter instances, the temporal autocorrelation may be modeled in the statistical analysis used when generating the neural network activation data, similar to how a hemodynamic response function is modeled in fMRI analysis techniques.

To simplify scaling, the Facebook Glactica-125M model was considered due to its limited number of layer output values. The model was imported into a Jupyter notebook in an NVIDIA-Docker container as a HuggingFace transformer. Pytorch hooks to save output tensor values were added to each module in the model. For inference, a wrapper function was developed to save the computed layer output tensor on an output token-by-token basis.

A series of block designed experiments were designed to probe different potential sub-networks based upon varying knowledge domains: Political science (Pol. Sci.), Medical Imaging (Med. Img.), Paleontology (Paleo.), Archeology (Arch.), and Pathology (Path.). To probe these fields, Chat-GPT 4.0 was instructed to develop 100 prompts for the Glactica model for each of these fields, as well as six sets of 100 prompts which explicitly do not include the seven listed fields.

These prompts were:

Example ChatGPT Prompts Used to Generate Input Datasets

Please generate a set of 100 short prompts for the Facebook Galactica model on the topic of
political science. Do not use any words more than 10 times in this list of prompts. Cover topics
including forms of government, theory of government, citizen engagement, and other broad
aspects of political science. Please return the results as a python list of strings. Again, DO
NOT repeat words across prompts more than 10 times.
Please generate a set of 100 short prompts for the Facebook Galactica model on the topic of
medical imaging and radiology. Do not use any words more than 10 times in this list of
prompts. Cover topics including the physics, medical applications, modalities, contrast,
acquisition, and reconstruction of medical images in radiology. Please return the results as a
python list of strings. Again, DO NOT repeat words across prompts more than 10 times.
Please generate a set of 100 short prompts for the Facebook Glactica model on the topic of
paleontology. Do not use any words more than 10 times in this list of prompts. Cover topics
including fosilization processes, types of fossils, evolutionary biology, methods and
techniques of paleontology, mass extinctions, and the ancient environment. Please return the
result as a python list of strings. Again, DO NOT repeat words across prompts more than 10
times.
Please generate a set of 100 short prompts for the Facebook Glactica model on the topic of
archeology. Do not use any words more than 10 times in this list of prompts. Cover topics
including historical and prehistorical periods, field survey, excavation, site mapping, artifact
analysis, archeometry, dating methods, lithic and ceramic analysis. Please return the result as a
python list of strings. Again, DO NOT repeat words across prompts more than 10 times.
Please generate a set of 100 short prompts for the Facebook Glactica model on the topic of
pathology. Do not use any words more than 10 times in this list of prompts. Cover topics
including anatomic and clinical pathology, biopsy, surgical sampling, sample staining,
immunohistochemistry, forensics, cancer and disease, and diagnostics. Please return the result
as a python list of strings. Again, DO NOT repeat words across prompts more than 10 times.
Please generate six sets of 100 short prompts for the Facebook Glactica model spread across
any topics OTHER THAN political science, medical imaging, paleontology, archeology, or
pathology. Do not use any words more than 10 times in each list of prompts. Each list should
include a wide assortment of topics. DO NOT INCLUDE topics of political science, medical
imaging, paleontology, archeology, or pathology. Please return the result as five separate
python lists of strings. Again, DO NOT repeat words across prompts in a list more than 10
times. The six lists should each contain a random selection of topics, and the lists should be
titled random prompts 1, random prompts 2, random prompts 3, random prompts 4, random
prompts 5, and random prompts 6

The natural language processing toolkit (NLTK) was used to generate an additional 100 strings of random words as an additional null control group.

Seven block designed experiments were created. Each experiment included a different task including: Political science versus Chat-GPT random prompts set 1, Medical imaging versus Chat-GPT random prompts set 2, Paleontology versus Chat-GPT random prompts set 3, Archeology versus Chat-GPT random prompts set 4, Pathology versus Chat-GPT random prompts set 5, NLTK random prompts versus Chat-GPT random prompts set 6, and Chat-GPT random prompts set 1 versus Chat-GPT random prompts set 2. Each block of each experiment included the input of one prompt from the specified set of prompts used to generate up to 10 tokens. Each experiment included eleven blocks of the “off” Chat-GPT generated random prompts and ten interleaved blocks of the listed task “on” blocks so that the experiment started and finished with an “off” block. This set of seven experiments was repeated five times.

To simplify the process of saving layer outputs, inference was performed on the central processing unit. Inference was performed on a server with an Intel Xeon processor with 12 cores and 192 Gb of RAM.

For each prompt, the above described wrapper function was used to call the LLM with a limit of 10 new tokens created for each model call. For each output token, layer outputs which were passed through the neural network to generate it were saved. The saved layer outputs were concatenated into an experiment-specific time series across all tokens generated in each experiment.

A linear model including a baseline and a binary regressor (0 for “off” and 1 for “on” blocks) was fit to each layer output value time series. The model was fit using the statsmodels general linear model (GLM) function. With 259,744 layer output values saved with each generated token, a layer output was defined to be active with a Bonferroni corrected p=0.0001 threshold. This model was fit independently for each layer output value across all experiments.

Analysis was performed to assess if the LLM exhibits consistent task-specific functional networks.

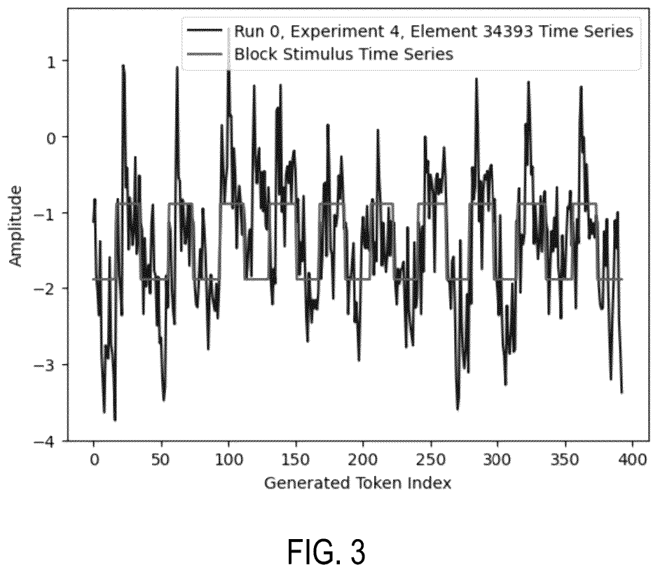

An example time series from an active layer output is shown in FIG. 3. The observed active layer output is plotted in blue, while the fit block design waveform with eleven blocks of “off” and ten blocks of “on” is shown in red. The active and inactive blocks are plainly apparent to the most casual observer, though there is clear variability of the layer output signal across the time series of inferred tokens.

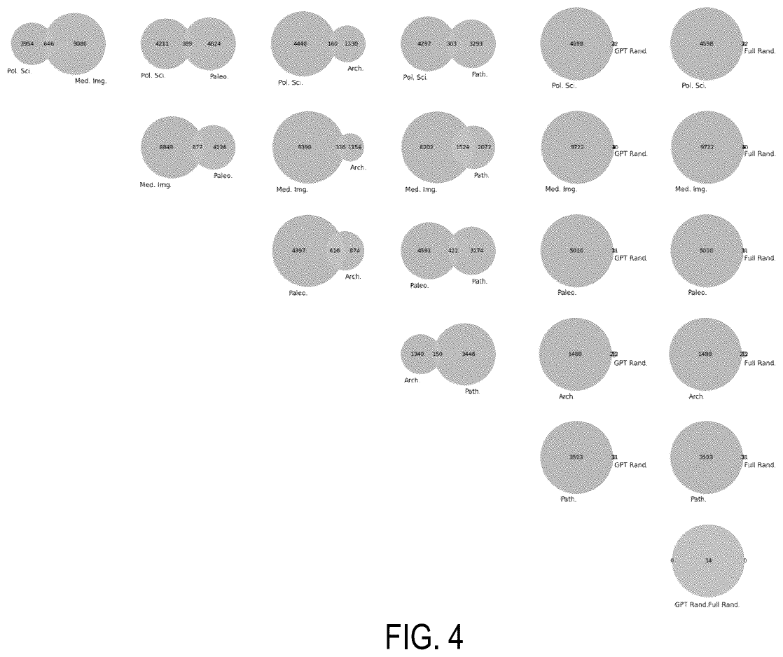

To assess the overlap of different functional networks, a series of Venn diagrams were considered across experiments in one run. The indices of layer output values which were found to be active in each task was compared with the indices of active layer output values in all other tasks in that run. These Venn diagrams are shown in FIG. 4. Labeling of the experimental tasks are abbreviated as described above, and the number of active layer outputs in each set are indicated on the plots. Unsurprisingly, activations with random inputs are quite limited. Interestingly, different tasks include significantly different numbers of activations-suggesting that some functional networks have representations which span greater numbers of observed layer output values. Suggestive of overlapping semantic representations, the greatest overlap was identified across the medical fields of medical imaging and pathology.

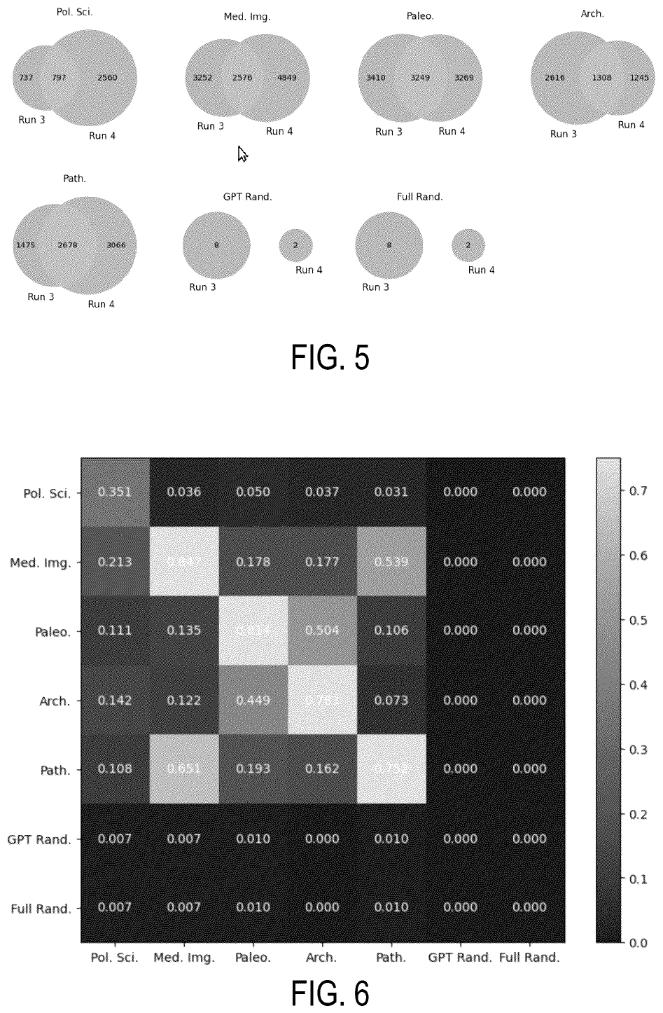

To assess the repeatability of the identified functional networks within the LLM, a series of Venn diagrams were considered across runs for each experiment. The indices of layer output values which were found to be active in one run were compared with the indices of active layer outputs in another run for each experiment. These Venn diagrams are shown in FIG. 5. Overlap within experiment task across runs is much greater than the overlap identified across tasks. The lack of total overlap is unsurprising as it is indicative of natural variation in network activation introduced by variance in provided prompts.

To assess the predictive power of the identified functional networks for political science, medical imaging, paleontology, archeology, and pathology, a network template based analysis was considered. One run of all seven experiments was segregated from the dataset. The set of layer outputs which were found to be active in at least three of the four remaining runs were identified for each experiment. These seven sets of layer outputs were defined to be the template functional networks associated with the seven tasks. Activations were computed on the experiments of the held out run. The intersection of the set of run-specific activations with each functional network was computed and normalized by number of active layer outputs in the functional network. This percentage of functional network active metric is shown for each experimental run (row) and compared functional network (column) in FIG. 6. As another example, the percentage of an experiment's activity that is outside of the considered functional network can be monitored and measured as an additional metric for neural network activation. Classification can also be made through a combination of these two metrics.

Unsurprisingly, random stimuli failed to yield any layer outputs which were consistently active across the template generation stage. This yielded functional networks of zero elements and undefined percentage of functional network active values in the right most columns and consistent values across both of the random input experiments (bottom rows). In cases where the functional networks were not empty, there is a clear correspondence of this metric being elevated when the experimental task aligns with the functional network template for that task. This is visualized by the elevated values along the diagonal of FIG. 6.

In this example study, the internal organizational structure of a deep neural network was analyzed using the systems and methods described in the present disclosure. This technique showed the existence of overlapping, but distinct functional networks within the Facebook Galactica-125M model which are preferentially responsive to prompts covering political science, medical imaging, paleontology, archeology, and pathology. These networks include elements which were shown to be active across multiple repeated experiments with similar but not identical tasks. Further, by considering the intersection of elements active in a task with the elements active in a pre-computed functional network, normalized to be the percentage of active elements in that network, one can identify the performed task.

This work is a step into a field of functional assessment of deep neural networks. As suggested with the presented results, the activity of a functional subnetwork can predict the presented task of the input. The experimental “task” design could, conversely, be defined based upon a labeling of the output tokens of the LLM rather than the input prompts as described herein. In such instances, the network's output, not the input, may be used as the regressor for the model in a retrospective analysis. The identified networks may be different from those identified in this work. Such networks may be of a different level of interest in cases where the goal is to better understand how to modulate the output of a neural network.

In such cases of assessing model performance based upon network activation, the activation could be used as a surrogate to assess model alignment. If a functional network associated with poor alignment is identified and that network is found to be active in a given inference task, inference could be censored or inference restarted with a different random state to achieve preferable model outputs. Thus, monitoring network activity could provide a means to predict and prevent divergent model performance.

The idea of a task-based assessment of model performance offers a unique opportunity for the retrospective analysis of model performance. For instance, if a model presents a persistent failure mode, a block designed stimulus could be created with a series of prompts that do and do not yield the failure. The network found to be active in the case of the failure mode could be of great interest in understanding and addressing the failure. In this case, the connections identified to be associated with the failure could be specifically unfrozen or otherwise targeted in fine tuning to mitigate the identified problem.

Because each layer output value is considered independently, the assessment of an experiment could be easily be parallelized in a blockwise manor across all layer output values. Once a set of functional networks are identified, a further reduction in computational requirements could be achieved by limiting analysis to the elements included in those networks.

In the broader field, the concept of “feature visualization” could be extended to consider identified networks instead of individual neurons. While standard feature visualization techniques seek to maximize the output of a priori identified neuron outputs, optimization could be pursued to maximize correlation of layer outputs with the average regression coefficients for an identified network. Thus, existing means of understanding the workings of deep neural networks can be complimentary to the emerging understanding of deep neural networks being organized into sets of overlapping functional networks.

There is an emerging understanding in the consideration of deep neural networks that they are organized into overlapping functional sub-networks. These functional networks can relate to different semantic representations, offering a significant increase of potential information encoding through the superposition of activations across numerous network modules. The systems and methods described in the present disclosure provides techniques for probing these networks. With this conceptual connection, the vast realm of experimental and analysis techniques of functional neuroimaging can be applied to enhance an understanding of deep neural networks. Further, with task- or outcome-specific functional networks identified within deep neural networks, the systems and methods described in the present disclosure offer the ability to identify opportunities to better align or fine tune models where these networks are mapped.

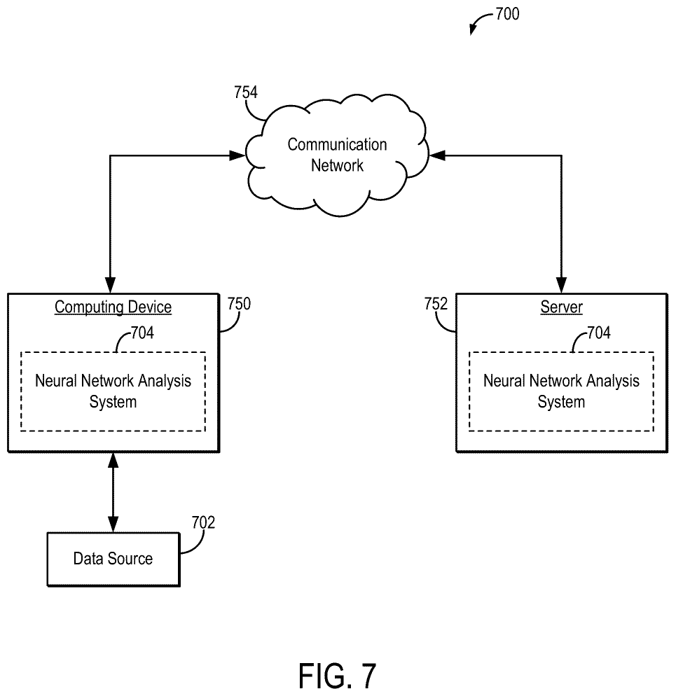

Referring now to FIG. 7, an example of a system 700 for neural network analysis in accordance with some embodiments of the systems and methods described in the present disclosure is shown. As shown in FIG. 7, a computing device 750 can receive one or more types of data (e.g., input data, first and second input datasets corresponding to first and second domains) from data source 702. In some embodiments, computing device 750 can execute at least a portion of a neural network analysis system 704 to generate neural network activation data from data received from the data source 702.

Additionally or alternatively, in some embodiments, the computing device 750 can communicate information about data received from the data source 702 to a server 752 over a communication network 754, which can execute at least a portion of the neural network analysis system 704. In such embodiments, the server 752 can return information to the computing device 750 (and/or any other suitable computing device) indicative of an output of the neural network analysis system 704.

In some embodiments, computing device 750 and/or server 752 can be any suitable computing device or combination of devices, such as a desktop computer, a laptop computer, a smartphone, a tablet computer, a wearable computer, a server computer, a virtual machine being executed by a physical computing device, and so on. The computing device 750 and/or server 752 can also reconstruct images from the data.

In some embodiments, data source 702 can be any suitable source of data (e.g., measurement data, images reconstructed from measurement data, processed image data, textual data, audio data, video data, other input data types), another computing device (e.g., a server storing measurement data, images reconstructed from measurement data, processed image data, textual data, audio data, video data, other input data types), and so on. In some embodiments, data source 702 can be local to computing device 750. For example, data source 702 can be incorporated with computing device 750 (e.g., computing device 750 can be configured as part of a device for measuring, recording, estimating, acquiring, or otherwise collecting or storing data). As another example, data source 702 can be connected to computing device 750 by a cable, a direct wireless link, and so on. Additionally or alternatively, in some embodiments, data source 702 can be located locally and/or remotely from computing device 750, and can communicate data to computing device 750 (and/or server 752) via a communication network (e.g., communication network 754).

In some embodiments, communication network 754 can be any suitable communication network or combination of communication networks. For example, communication network 754 can include a Wi-Fi network (which can include one or more wireless routers, one or more switches, etc.), a peer-to-peer network (e.g., a Bluetooth network), a cellular network (e.g., a 3G network, a 4G network, etc., complying with any suitable standard, such as CDMA, GSM, LTE, LTE Advanced, WiMAX, etc.), other types of wireless network, a wired network, and so on. In some embodiments, communication network 754 can be a local area network, a wide area network, a public network (e.g., the Internet), a private or semi-private network (e.g., a corporate or university intranet), any other suitable type of network, or any suitable combination of networks. Communications links shown in FIG. 7 can each be any suitable communications link or combination of communications links, such as wired links, fiber optic links, Wi-Fi links, Bluetooth links, cellular links, and so on.

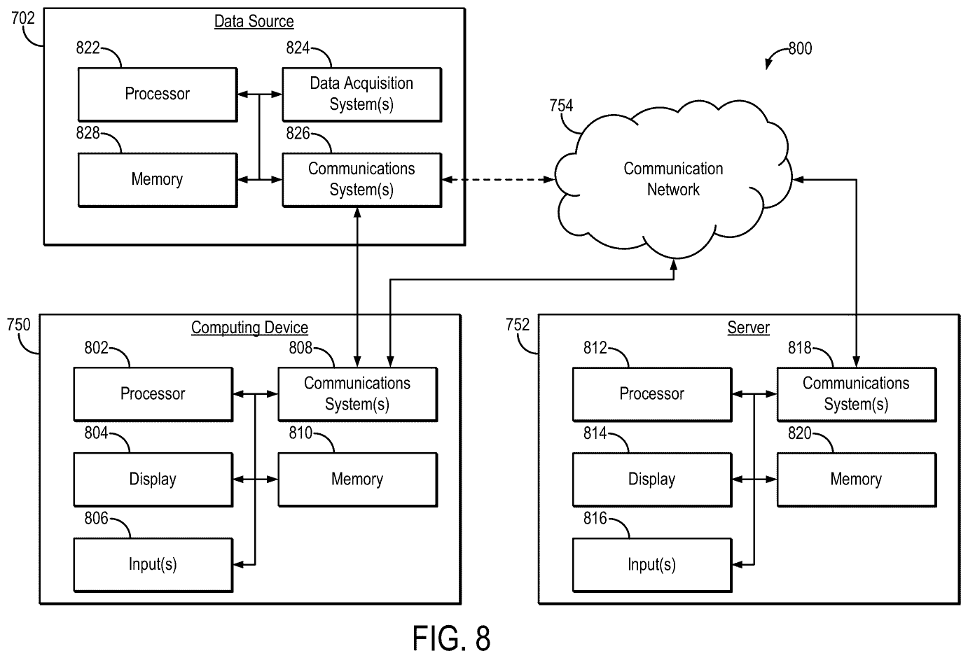

Referring now to FIG. 8, an example of hardware 800 that can be used to implement data source 702, computing device 750, and server 752 in accordance with some embodiments of the systems and methods described in the present disclosure is shown.

As shown in FIG. 8, in some embodiments, computing device 750 can include a processor 802, a display 804, one or more inputs 806, one or more communication systems 808, and/or memory 810. In some embodiments, processor 802 can be any suitable hardware processor or combination of processors, such as a central processing unit (“CPU”), a graphics processing unit (“GPU”), and so on. In some embodiments, display 804 can include any suitable display devices, such as a liquid crystal display (“LCD”) screen, a light-emitting diode (“LED”) display, an organic LED (“OLED”) display, an electrophoretic display (e.g., an “e-ink” display), a computer monitor, a touchscreen, a television, and so on. In some embodiments, inputs 806 can include any suitable input devices and/or sensors that can be used to receive user input, such as a keyboard, a mouse, a touchscreen, a microphone, and so on.

In some embodiments, communications systems 808 can include any suitable hardware, firmware, and/or software for communicating information over communication network 754 and/or any other suitable communication networks. For example, communications systems 808 can include one or more transceivers, one or more communication chips and/or chip sets, and so on. In a more particular example, communications systems 808 can include hardware, firmware, and/or software that can be used to establish a Wi-Fi connection, a Bluetooth connection, a cellular connection, an Ethernet connection, and so on.

In some embodiments, memory 810 can include any suitable storage device or devices that can be used to store instructions, values, data, or the like, that can be used, for example, by processor 802 to present content using display 804, to communicate with server 752 via communications system(s) 808, and so on. Memory 810 can include any suitable volatile memory, non-volatile memory, storage, or any suitable combination thereof. For example, memory 810 can include random-access memory (“RAM”), read-only memory (“ROM”), electrically programmable ROM (“EPROM”), electrically erasable ROM (“EEPROM”), other forms of volatile memory, other forms of non-volatile memory, one or more forms of semi-volatile memory, one or more flash drives, one or more hard disks, one or more solid state drives, one or more optical drives, and so on. In some embodiments, memory 810 can have encoded thereon, or otherwise stored therein, a computer program for controlling operation of computing device 750. In such embodiments, processor 802 can execute at least a portion of the computer program to present content (e.g., images, user interfaces, graphics, tables), receive content from server 752, transmit information to server 752, and so on. For example, the processor 802 and the memory 810 can be configured to perform the methods described herein (e.g., the method of FIG. 1, the method of FIG. 2).

In some embodiments, server 752 can include a processor 812, a display 814, one or more inputs 816, one or more communications systems 818, and/or memory 820. In some embodiments, processor 812 can be any suitable hardware processor or combination of processors, such as a CPU, a GPU, and so on. In some embodiments, display 814 can include any suitable display devices, such as an LCD screen, LED display, OLED display, electrophoretic display, a computer monitor, a touchscreen, a television, and so on. In some embodiments, inputs 816 can include any suitable input devices and/or sensors that can be used to receive user input, such as a keyboard, a mouse, a touchscreen, a microphone, and so on.

In some embodiments, communications systems 818 can include any suitable hardware, firmware, and/or software for communicating information over communication network 754 and/or any other suitable communication networks. For example, communications systems 818 can include one or more transceivers, one or more communication chips and/or chip sets, and so on. In a more particular example, communications systems 818 can include hardware, firmware, and/or software that can be used to establish a Wi-Fi connection, a Bluetooth connection, a cellular connection, an Ethernet connection, and so on.

In some embodiments, memory 820 can include any suitable storage device or devices that can be used to store instructions, values, data, or the like, that can be used, for example, by processor 812 to present content using display 814, to communicate with one or more computing devices 750, and so on. Memory 820 can include any suitable volatile memory, non-volatile memory, storage, or any suitable combination thereof. For example, memory 820 can include RAM, ROM, EPROM, EEPROM, other types of volatile memory, other types of non-volatile memory, one or more types of semi-volatile memory, one or more flash drives, one or more hard disks, one or more solid state drives, one or more optical drives, and so on. In some embodiments, memory 820 can have encoded thereon a server program for controlling operation of server 752. In such embodiments, processor 812 can execute at least a portion of the server program to transmit information and/or content (e.g., data, images, a user interface) to one or more computing devices 750, receive information and/or content from one or more computing devices 750, receive instructions from one or more devices (e.g., a personal computer, a laptop computer, a tablet computer, a smartphone), and so on.

In some embodiments, the server 752 is configured to perform the methods described in the present disclosure. For example, the processor 812 and memory 820 can be configured to perform the methods described herein (e.g., the method of FIG. 1, the method of FIG. 2).

In some embodiments, data source 702 can include a processor 822, one or more data acquisition systems 824, one or more communications systems 826, and/or memory 828. In some embodiments, processor 822 can be any suitable hardware processor or combination of processors, such as a CPU, a GPU, and so on. In some embodiments, the one or more data acquisition systems 824 are generally configured to acquire data, images, or both, and can include imaging systems, sensors, and/or other measurement systems. Additionally or alternatively, in some embodiments, the one or more data acquisition systems 824 can include any suitable hardware, firmware, and/or software for coupling to and/or controlling operations of data acquisition systems (e.g., imaging systems, other measurement systems). In some embodiments, one or more portions of the data acquisition system(s) 824 can be removable and/or replaceable.

Note that, although not shown, data source 702 can include any suitable inputs and/or outputs. For example, data source 702 can include input devices and/or sensors that can be used to receive user input, such as a keyboard, a mouse, a touchscreen, a microphone, a trackpad, a trackball, and so on. As another example, data source 702 can include any suitable display devices, such as an LCD screen, an LED display, an OLED display, an electrophoretic display, a computer monitor, a touchscreen, a television, etc., one or more speakers, and so on.

In some embodiments, communications systems 826 can include any suitable hardware, firmware, and/or software for communicating information to computing device 750 (and, in some embodiments, over communication network 754 and/or any other suitable communication networks). For example, communications systems 826 can include one or more transceivers, one or more communication chips and/or chip sets, and so on. In a more particular example, communications systems 826 can include hardware, firmware, and/or software that can be used to establish a wired connection using any suitable port and/or communication standard (e.g., VGA, DVI video, USB, RS-232, etc.), Wi-Fi connection, a Bluetooth connection, a cellular connection, an Ethernet connection, and so on.

In some embodiments, memory 828 can include any suitable storage device or devices that can be used to store instructions, values, data, or the like, that can be used, for example, by processor 822 to control the one or more data acquisition systems 824, and/or receive data from the one or more data acquisition systems 824; to generate images from data; present content (e.g., data, images, a user interface) using a display; communicate with one or more computing devices 750; and so on. Memory 828 can include any suitable volatile memory, non-volatile memory, storage, or any suitable combination thereof. For example, memory 828 can include RAM, ROM, EPROM, EEPROM, other types of volatile memory, other types of non-volatile memory, one or more types of semi-volatile memory, one or more flash drives, one or more hard disks, one or more solid state drives, one or more optical drives, and so on. In some embodiments, memory 828 can have encoded thereon, or otherwise stored therein, a program for controlling operation of data source 702. In such embodiments, processor 822 can execute at least a portion of the program to generate images, transmit information and/or content (e.g., data, images, a user interface) to one or more computing devices 750, receive information and/or content from one or more computing devices 750, receive instructions from one or more devices (e.g., a personal computer, a laptop computer, a tablet computer, a smartphone, etc.), and so on.

In some embodiments, any suitable computer-readable media can be used for storing instructions for performing the functions and/or processes described herein. For example, in some embodiments, computer-readable media can be transitory or non-transitory. For example, non-transitory computer-readable media can include media such as magnetic media (e.g., hard disks, floppy disks), optical media (e.g., compact discs, digital video discs, Blu-ray discs), semiconductor media (e.g., RAM, flash memory, EPROM, EEPROM), any suitable media that is not fleeting or devoid of any semblance of permanence during transmission, and/or any suitable tangible media. As another example, transitory computer-readable media can include signals on networks, in wires, conductors, optical fibers, circuits, or any suitable media that is fleeting and devoid of any semblance of permanence during transmission, and/or any suitable intangible media.

As used herein in the context of computer implementation, unless otherwise specified or limited, the terms “component,” “system,” “module,” “framework,” and the like are intended to encompass part or all of computer-related systems that include hardware, software, a combination of hardware and software, or software in execution. For example, a component may be, but is not limited to being, a processor device, a process being executed (or executable) by a processor device, an object, an executable, a thread of execution, a computer program, or a computer. By way of illustration, both an application running on a computer and the computer can be a component. One or more components (or system, module, and so on) may reside within a process or thread of execution, may be localized on one computer, may be distributed between two or more computers or other processor devices, or may be included within another component (or system, module, and so on).

In some implementations, devices or systems disclosed herein can be utilized or installed using methods embodying aspects of the disclosure. Correspondingly, description herein of particular features, capabilities, or intended purposes of a device or system is generally intended to inherently include disclosure of a method of using such features for the intended purposes, a method of implementing such capabilities, and a method of installing disclosed (or otherwise known) components to support these purposes or capabilities. Similarly, unless otherwise indicated or limited, discussion herein of any method of manufacturing or using a particular device or system, including installing the device or system, is intended to inherently include disclosure, as embodiments of the disclosure, of the utilized features and implemented capabilities of such device or system.

The present disclosure has described one or more preferred embodiments, and it should be appreciated that many equivalents, alternatives, variations, and modifications, aside from those expressly stated, are possible and within the scope of the invention.

1. A method for analyzing an artificial neural network, comprising:
accessing input data with a computer system, wherein the input data comprise a first input dataset and a second input dataset;
accessing a pretrained neural network with the computer system, the pretrained neural network comprising a plurality of layers;
forming a block-sequence of the input data that defines an order to apply the first input data set and the second input dataset to the pretrained neural network;
generating a time-series of layer output values by:
applying the input data to the pretrained neural network according to the block-sequence;
storing an output of each of the plurality of layers generated when applying the input data to the pretrained neural network according to the block-sequence, wherein the output of each of the plurality of layers are ordered based on the block-sequence and define the time-series of layer output values; and
generating neural network activation data by processing the time-series of layer output values with the computer system, wherein the neural network activation data indicate a degree of activation of each of the plurality of layers of the pretrained neural network in response to at least one of the first input dataset or the second input dataset.

2. The method of claim 1, wherein the first input data set corresponds to a first domain and the second input dataset corresponds to a second domain.

3. The method of claim 2, wherein the first domain comprises a first knowledge domain.

4. The method of claim 3, wherein the second domain comprises a second knowledge domain.

5. The method of claim 4, wherein at least one of the first knowledge domain or second knowledge domain comprise at least one of a medical knowledge domain, a biological knowledge domain, a financial knowledge domain, an economic knowledge domain, a social knowledge domain, a marketing knowledge domain, or a scientific knowledge domain.

6. The method of claim 1, wherein the input data comprise at least one of textual information, numerical data, audio data, visual data, or sensor data.

7. The method of claim 1, wherein at least one of the first input dataset and the second input dataset comprise medical images.

8. The method of claim 1, wherein at least one of the first input dataset and the second input dataset comprise textual data.

9. The method of claim 1, wherein generating the neural network activation data comprises applying the time-series of layer output values to a statistical model.

10. The method of claim 9, wherein the statistical model comprises a linear model.

11. The method of claim 10, wherein the linear model comprises a general linear model.

12. The method of claim 9, wherein the statistical model comprises a nonlinear function.

13. The method of claim 1, wherein the neural network activation data comprise an activation heat map that depicts activations in the plurality of layers of the pretrained neural network based on different inputs in the input data.

14. The method of claim 1, further comprising processing the neural network activation data to determine a model alignment of the pretrained neural network relative to an objective of the pretrained neural network.

15. The method of claim 14, further comprising updating an output of at least one of a layer in the pretrained neural network, a subgroup of nodes in a layer of the pretrained neural network, or a node in a layer of the pretrained neural network based on the neural network activation data to realign the pretrained neural network relative to the objective of the pretrained neural network.

16. The method of claim 14, further comprising updating an input to at least one of a layer in the pretrained neural network, a subgroup of nodes in a layer of the pretrained neural network, or a node in a layer of the pretrained neural network based on the neural network activation data to realign the pretrained neural network relative to the objective of the pretrained neural network.

17. The method of claim 14, further comprising updating an input to at least one of a layer in the pretrained neural network, a subgroup of nodes in a layer of the pretrained neural network, or a node in a layer of the pretrained neural network based on the neural network activation data to realign the pretrained neural network relative to the objective of the pretrained neural network.

18. The method of claim 1, further comprising processing the neural network activation data to indicate at least one of a layer in the pretrained neural network, a subgroup of nodes in a layer of the pretrained neural network, or a node in a layer of the pretrained neural network to be updated to improve performance of the pretrained neural network.

19. The method of claim 18, further comprising at least one of retraining or fine tuning the at least one of the layer in the pretrained neural network, the subgroup of nodes in a layer of the pretrained neural network, or the node in a layer of the pretrained neural network indicated to be updated to improve the performance of the pretrained neural network.

20. The method of claim 1, further comprising processing the neural network activation data to identify at least one of a layer in the pretrained neural network, a subgroup of nodes in a layer of the pretrained neural network, or a node in a layer of the pretrained neural network to be modulated to adjust a behavior of the pretrained neural network.

21. The method of claim 20, further comprising modulating the pretrained neural network by adjusting model weights associated with the identified at least one of the layer in the pretrained neural network, the subgroup of nodes in the layer of the pretrained neural network, or the node in the layer of the pretrained neural network to at least one of upregulate or downregulate activations in the identified at least one of the layer in the pretrained neural network, the subgroup of nodes in the layer of the pretrained neural network, or the node in the layer of the pretrained neural network.

22. The method of claim 1, further comprising processing the neural network activation data to identify at least one of an inactive subnetwork, an inactive subgroup of nodes, or an inactive node in the pretrained neural network.

23. The method of claim 22, further comprising generating a compressed neural network by removing the at least one of the inactive subnetwork, the inactive subgroup of nodes, or the inactive node in the pretrained neural network.

24. A method for analyzing an artificial neural network, comprising:
accessing input data with a computer system, wherein the input data comprise a structured set of inputs;
accessing a pretrained neural network with the computer system, the pretrained neural network comprising a plurality of layers;
sequentially applying the structured set of inputs of the input data to the pretrained neural network, generating a time-series of layer output values;
generating neural network activation data by fitting the time-series of layer output values to a statistical model.

25. The method of claim 24, wherein the statistical model comprises a linear model.

26. The method of claim 25, wherein the linear model comprises a general linear model.

27. The method of claim 24, wherein the statistical model comprises a nonlinear function.

28. The method of claim 24, wherein the structured set of inputs are sequentially applied to the pretrained neural network according to a block design.

29. The method of claim 28, wherein the block-sequence design comprises an off-on-off block design.

30. The method of claim 24, wherein the structured set of inputs are sequentially applied to the pretrained neural network according to an event-related design.

31. The method of claim 24, wherein generating neural network activation data by fitting the time-series of layer output values to a statistical model comprises using the input data as a regressor.

32. The method of claim 24, wherein generating neural network activation data by fitting the time-series of layer output values to a statistical model comprises using outputs of the neural network as a regressor.

33. The method of claim 32, wherein the outputs of the neural network used as the regressor comprise at least one of an active layer output or a set of layer outputs.

34. The method of claim 24, wherein the neural network activation data indicate connections between layer output values across the neural network.

35. The method of claim 24, wherein the neural network activation data comprise an activation heat map that depicts activations in the plurality of layers of the pretrained neural network based on different inputs in the input data.

36. The method of claim 24, further comprising processing the neural network activation data to determine a model alignment of the pretrained neural network relative to an objective of the pretrained neural network.

37. The method of claim 36, further comprising updating an output of at least one of a layer in the pretrained neural network, a subgroup of nodes in a layer of the pretrained neural network, or a node in a layer of the pretrained neural network based on the neural network activation data to realign the pretrained neural network relative to the objective of the pretrained neural network.

38. The method of claim 36, further comprising updating an input to at least one of a layer in the pretrained neural network, a subgroup of nodes in a layer of the pretrained neural network, or a node in a layer of the pretrained neural network based on the neural network activation data to realign the pretrained neural network relative to the objective of the pretrained neural network.

39. The method of claim 36, further comprising updating an input to at least one of a layer in the pretrained neural network, a subgroup of nodes in a layer of the pretrained neural network, or a node in a layer of the pretrained neural network based on the neural network activation data to realign the pretrained neural network relative to the objective of the pretrained neural network.

40. The method of claim 24, further comprising processing the neural network activation data to indicate at least one of a layer in the pretrained neural network, a subgroup of nodes in a layer of the pretrained neural network, or a node in a layer of the pretrained neural network to be updated to improve performance of the pretrained neural network.

41. The method of claim 40, further comprising at least one of retraining or fine tuning the at least one of the layer in the pretrained neural network, the subgroup of nodes in a layer of the pretrained neural network, or the node in a layer of the pretrained neural network indicated to be updated to improve the performance of the pretrained neural network.

42. The method of claim 24, further comprising processing the neural network activation data to identify at least one of a layer in the pretrained neural network, a subgroup of nodes in a layer of the pretrained neural network, or a node in a layer of the pretrained neural network to be modulated to adjust a behavior of the pretrained neural network.

43. The method of claim 42, further comprising modulating the pretrained neural network by adjusting model weights associated with the identified at least one of the layer in the pretrained neural network, the subgroup of nodes in the layer of the pretrained neural network, or the node in the layer of the pretrained neural network to at least one of upregulate or downregulate activations in the identified at least one of the layer in the pretrained neural network, the subgroup of nodes in the layer of the pretrained neural network, or the node in the layer of the pretrained neural network.

44. The method of claim 24, further comprising processing the neural network activation data to identify at least one of an inactive subnetwork, an inactive subgroup of nodes, or an inactive node in the pretrained neural network.

45. The method of claim 44, further comprising generating a compressed neural network by removing the at least one of the inactive subnetwork, the inactive subgroup of nodes, or the inactive node in the pretrained neural network.
